(19) United States
(12) Patent Application Publication
(10) Pub. No.: US 2003/0160361 A1
(43) Pub. Date: Aug. 28, 2003

(54) Reinforced moulded article and method of producing same

(76) Inventor: Christopher James Whiteley, Buckingham (GB)

Correspondence Address: JOEL D. SKINNER, JR., SKINNER AND ASSOCIATES, 212 COMMERCIAL ST., HUDSON, WI, 54016, US

(21) Appl. No.: 10/258,922

(22) PCT Filed: Apr. 27, 2001
(86) PCT No.: PCT/GB01/01886

(30) Foreign Application Priority Data
Apr. 27, 2000 (GB) 0010156.8

(51) Int. Cl. B32B 31/06

(52) U.S. Cl. 264/261

(57) ABSTRACT

A method of fabricating a moulded article comprises placing elongate reinforcing members (14) within a mould and then compression moulding a plastics material around the reinforcing members (14).

This invention relates to a reinforced moulded article, and in particular to a reinforced plastics moulded article, and to a method of producing such an article. Reinforced plastics moulded articles of the type to which the invention relates may be suitable for use as road plates, load bearing panels, barriers, partitions, walkways or roadways, or for shoreing up the sides of excavations. Further applications include bridge decking, manhole/cavity covers, temporary roadways and load spreading pads for example for use beneath the feet or cranes or the like.

Plastics road plates for positioning over excavations formed, in footpaths or roadways are well known In one known form a plastics moulded panel is provided, on one surface thereof, with a matrix of ribs, the ribs serving to inhibit flexing of the panel. Such road plates perform satisfactorily under relatively low load conditions, but under higher loadings the ribs tend to deform or the intersections between ribs fail allowing the panel to flex to an unacceptable degree. Another known type of road plate comprises two skins of a plastics material spaced apart from one another. A core fills the space between the skins. In use, if a load is applied to the road plate, one of the skins will be in compression, and the other in torsion. A shear force is transmitted between the skins through the core, and this requires the core to be well adhered to the skins and to be of a material that will not disintegrate on repeated flexing. These constraints limit the maximum load that can be carried by the road plate. A further disadvantage associated with this type of road plate is that the manufacturing process used is typically a hand lay up process or a low pressure resin injection moulding process, and these processes are relatively slow.

It is an object of the invention to provide a moulded article and a manufacturing method in which these disadvantages are of reduced effect.

According to a first aspect of the invention there is provided a plastics moulded article having elongate reinforcing members located therein.

The elongate reinforcing members are conveniently in the form of steel rods. The steel rods are preferably provided with a surface texture, providing a mechanical lock between the rods and the plastics material. The surface texture may comprise, for example, ribs or screw threads. Depending upon the application, it may be preferred to use elongate reinforcing members of another material, for example a suitable plastics material.

The elongate reinforcing members conveniently define a matrix. The members are preferably welded to one another. Such welding preferably occurs prior to moulding the plastics material around the reinforcing members.

The article is conveniently of generally planar form, ribs being provided upon a surface thereof, the reinforcing members being located within the ribs.

According to another aspect of the invention there is provided a method of fabricating a reinforced moulded article comprising the steps of placing a plurality of elongate reinforcing members within a mould, and compression moulding a plastics material around the reinforcing members.

The reinforcing members are conveniently secured to one another prior to being placed within the mould.

The reinforcing members are conveniently welded to one another.

Preferably, the mould is shaped to define channels which form ribs in the moulded article, the reinforcing members being placed within the channels of the mould.

The elongate reinforcing members are conveniently of metallic form and are preferably steel. They may be provided with a surface texture, for example in the form of ribs or screw threads. Alteratively, the reinforcing members may be of a suitable plastics material.

The invention will further be described, by way of example, with reference to the accompanying drawings, in which:

FIG. 1 is a diagrammatic view of the underside of a moulded article in accordance with an embodiment of the invention; and

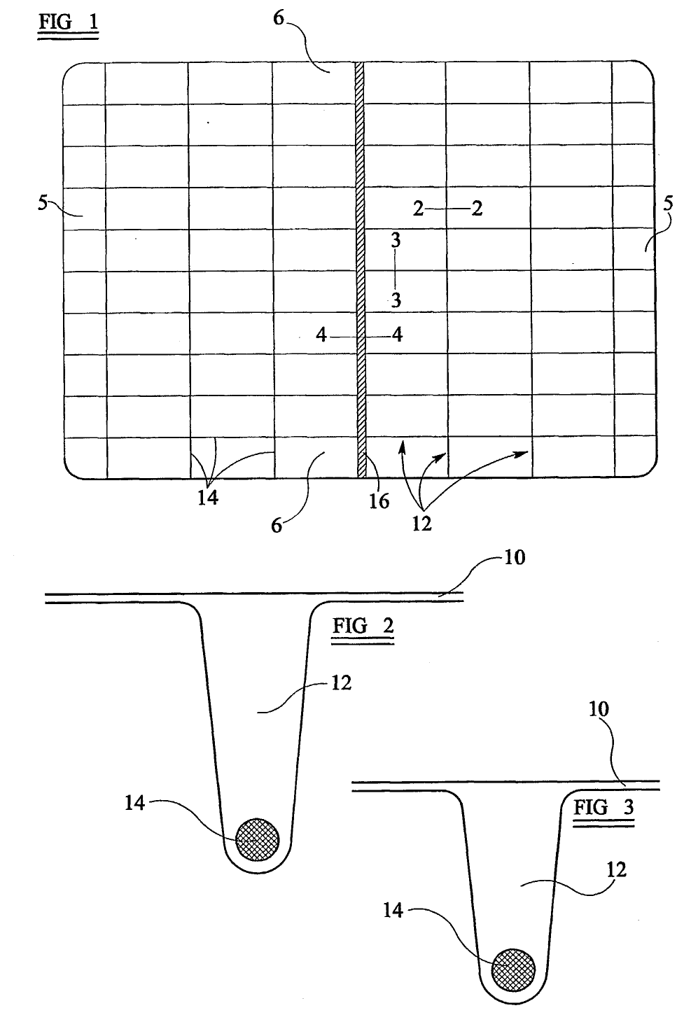

FIGS. 2 to 6 are sectional views along the Lines 2-2, 3-3, 4-4, 5-5 and 6-6 of FIG. 1.

The moulded plastics article illustrated in the accompanying drawings is a road plate intended to cover a channel or cavity which has been dug in a road surface or walkway to permit access to underground service pipes, cables or the like. The road plate comprises a plastics moulding having a generally flat, panel-like, upper part 10 from which a series of ribs 12 depend The ribs 12 extend both longitudinally and laterally of the road plate. As illustrated in the drawings, the upper part 10 is conveniently of slightly convex form as this improves the ability of the road plate to withstand high loadings.

As illustrated most clearly in FIGS. 2 and 3, most of the ribs 12 have, buried therein, an elongate reinforcing member in the form of a length of steel rod 14. Each steel rod 14 extends over substantially the full length/width of the road plate, terminating very slightly short of the edges of the road plate so as to be fully enclosed by the plastic material of the rib 12. The rods 14 are located close to the lowermost edge of each rib 12.

The steel rods 14 are conveniently of 10 mm diameter, although it will be appreciated that rods of other diameters could be used. Further, reinforcing members of other cross-sectional shapes could be used. The rods 14 are provided with a series of ribs which, in use, form a mechanical lock with the plastics material of the ribs 12, thus inhibiting relative axial movement of the plastics material of the ribs 12 relative to the rods 14. An additional mechanical lock is formed where the rods 14 pass over and are secured to one another.

As illustrated in FIGS. 1 and 5, the ribs 12 and rods 14 which extend across the width of the road plate are not equally spaced but rather are spaced in such a manner as to ensure that those parts of the road plate which require the greatest level of reinforcement are provided with rods 14 located relatively close to one another, the rods 14 being spaced apart by a greater distance where less reinforcement is required. The ribs 12 could be equally spaced if desired. The rods 14 and ribs 12 which extend along the length of the road plate may similarly be irregularly spaced, but in the illustrated embodiment are equally spaced.

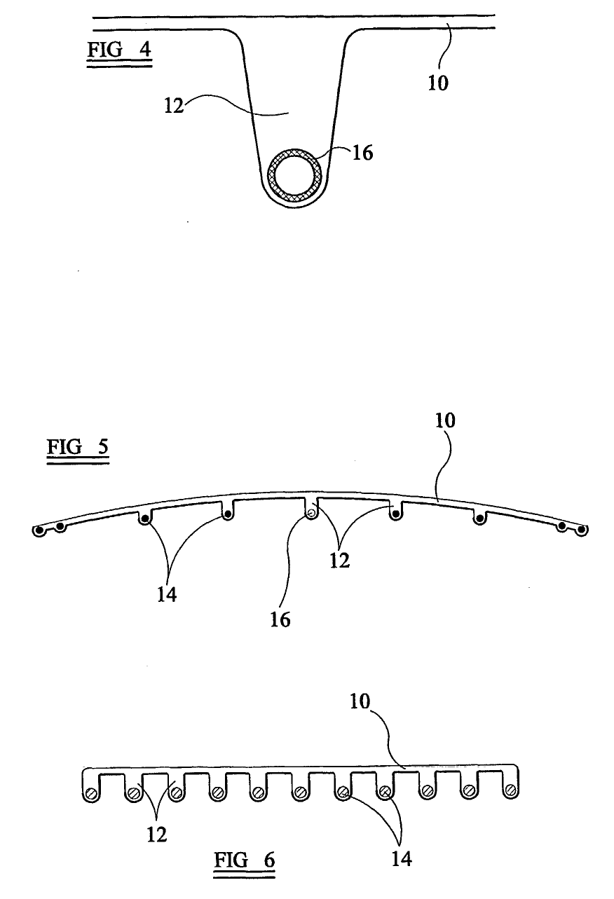

FIGS. 1 and 4 illustrate the central rod 16 extending across the width of the road plate. The central rod 16 differs from the rod 14 in that it is of tubular form and also in that it is of larger diameter, for example 20 mm. Again, a surface texture may be provided to form a mechanical lock with the plastics material. The use of a tubular member as one of the reinforcing members allows cables or the like to be carried by the road plate, if desired, and may also enhance the load bearing capacity of the road plate.

The road plate is manufactured by prefabricating a matrix comprising the rods 14 and the rod 16, welding or otherwise securing the rods 14, 16 to one another. The matrix is located within a compression moulding press, the mould being shaped to define channels used to form the ribs 12. The matrix is fitted into the channels of the mould. Once correctly positioned, a suitable plastics material is introduced into the mould, the plastics material being compression moulded around the matrix to fully enclose the rods 14, 16 and becoming locked thereto such that a load applied to the road plate is transmitted to the rods 14, 16.

If desired, the upper surface of the upper part 10 may be textured to reduce the risk of slipping. The texture may be applied during the moulding process. Alternatively, a separate textured sheet may be secured to the upper part 10, for example by adhesive.

The invention is advantageous in that where an article includes ribs which cross over one another, when a load is applied to such an article, there is a tendency for one or more of the ribs to fail at the intersection By providing reinforcing members in both ribs, the reinforcing members extending continuously over substantially the full length/width of the article, then the risk of such failure is reduced and even if the ribs fail, the load is transmitted along the broken ribs by the reinforcing member thus maintaining the load bearing capacity of the article.

Although not illustrated, the road plate may be provided, along an edge thereof, with several protruding lugs, the lugs being engageable with formations provided along an edge of a second, adjacent, road plate permitting the road plates to be secured to one another using, for example, bolts. Such a connection technique can be used to ensure that load bearing capability of a road plate assembly is not significantly weaker at the edges of each road plate than it is at the centre of each road plate.

Although the description hereinbefore is of a road plate, it will be appreciated that the invention is applicable to other moulded articles, for example panels for use in shoreing up the sides of excavated cavities, manhole covers, bridge decking or boards for use on scaffolding, temporary roadways or temporary footpaths. The invention could also be used in load bearing pads for use with the feet of cranes or similar devices or many other applications. The invention is particularly applicable generally planar to load bearing panels where the load is always applied in the same direction, thus it can be ensured that the ribs 12 and the rods 14 are always under tension, the panel 10 experiencing a compressive load. Panels of this type are relatively lightweight but capable of bearing high loads. Manufacture using the method described hereinbefore can be achieved quickly and economically.

Another application in which the invention can be used is in safety or security barriers of the type including a pair of uprights interconnected by one or more cross bars. The reinforcing members may extend along the uprights, and may also be provided within one or more of the cross bars. It will be appreciated that the openings may be formed between the crossbars, if desired.

1. A method of fabricating a reinforced moulded article comprising placing a plurality of elongate reinforcing members within a mould, and compression moulding a plastics material around the reinforcing members.

2. A method as claimed in claim 1, wherein the reinforcing members are secured to one another prior to moulding the plastics material.

3. A method as claimed in claim 2, wherein the reinforcing members are secured to one another by welding.

4. A method as claimed in any one of the preceding claims, wherein the mould is shaped to define channels which form ribs in the moulded article, the reinforcing members being placed within the channels of the mould, in use.

5. A method as claimed in any one of the preceding claims, wherein the reinforcing members are of metallic form.

6. A method as claimed in claim 5, wherein the reinforcing members are of steel.

7. A method as claimed in any one of the preceding claims, wherein the reinforcing members are provided with a surface texture.

8. A method as claimed in any one of claims 1 to 4, wherein the reinforcing members are of plastics form

9. A moulded plastics article having elongate reinforcing members located therein fabricated using the method of any one of claims 1 to 8.

10. A moulded plastics article as claimed in claim 9 and adapted for use as one of a road plate, a load bearing panel, a barrier, a partition, a walkway, a road way, a bridge decking, a manhole cover, a load spreading pad and a panel for use in shoreing excavations.

11. A method of fabricating a moulded article substantially as hereinbefore described with reference to the accompanying drawings.

12. A reinforced moulded article substantially as hereinbefore described with reference to the accompanying drawings.
